(19) United States
(12) Patent Application Publication
(10) Pub. No.: US 2010/0131148 A1
(43) Pub. Date: May 27, 2010

(54) SYSTEM AND METHOD FOR ESTIMATED DRIVER INTENTION FOR DRIVER ASSISTANCE SYSTEM CONTROL

(76) Inventors: Jaime Camhi, Sunnyvale, CA (US); Joshua P. Switkes, Menlo Park, CA (US); Dirk Langer, Palo Alto, CA (US); Arne Stoschek, Palo Alto, CA (US)

Correspondence Address: KENYON & KENYON LLP, ONE BROADWAY, NEW YORK, NY, 10004, US

(21) Appl. No.: 12/323,890

(22) Filed: Nov. 26, 2008

(51) Int. Cl. G06F 7/00

(52) U.S. Cl. 701/29

(57) ABSTRACT

A system and method relate to estimating a driver intention for driver assistance systems control, including an analysis device that receives data from each of a vehicle environment sensor, a vehicle dynamics sensor, and a driver attributes sensor, such that the analysis device makes a prediction of the driver intention based on the received data. A control device controls a vehicle and a driver partially based on the predicted driver intention.

### FIELD OF THE INVENTION

The present invention relates to a system and method for estimating driver intention for driver assistance system control.

### BACKGROUND INFORMATION

Driver assistance systems (DAS) are designed to improve driving safety and comfort by a variety of different methods. These methods may include, for example,
a) providing information to the driver,
b) automating certain tasks for the driver, and
c) controlling vehicle dynamics in a way that would be otherwise impossible for a human driver.

Examples of driver assistance systems include Adaptive Cruise Control (ACC), Anti-Lock Braking Systems (ABS), collision warning systems, and others.

Some of these driver assistance systems rely on information about the vehicle environment in order to determine their behavior. However, none of these systems reliably accounts for driver intention. In this regard, information about driver intention may play an important role in determining a system's behavior in a particular situation.

For example, a lane departure warning (LDW) system may sense that a vehicle is crossing a lane marking painted on a roadway. However, the LDW system has no information about whether the lane crossing is intended by the driver of the vehicle. Because of this lack of knowledge about driver intention, the system may output a warning related to the lane crossing even if such a lane crossing is actually intended by the driver. As a result, this may lead a driver to ignore future warnings, even those that may be valid. Further, such false alarms may induce a driver to turn off the system entirely, eliminating any potential utility of the LDW system.

Some driver assistance systems may make very simple assumptions regarding driver intention. For example, Anti-Lock Braking Systems (ABS) may sense high braking forces and simply assume that a driver desires to stop the vehicle as quickly as possible. Based upon this simple assumption, the ABS system may assist the driver in quickly stopping the vehicle by monitoring wheel speed and adjusting the braking power in order to prevent wheel lockup.

Other driver assistance systems may require more complex information regarding driver intention. However, existing driver assistance systems only allow the driver to decide whether the system is activated or not. Thus, active analysis of information regarding driver intention has not previously been available to any driver assistance systems that may require complex recognition of driver intention.

For example, adaptive headlight systems may take into account information about vehicle dynamics. This information about vehicle dynamics may include the vehicle pitch, i.e., the change of angle between the roadway plane and the vehicle's horizontal plane taken about a horizontal axis perpendicular to the direction of travel of the vehicle, and may also include a steering wheel angle. Based on this information about vehicle dynamics, adaptive headlight systems may compensate for the change in vehicle pitch, and also aim the headlight beam towards the steered direction. In this manner, adaptive headlight systems may make a simple assumption of the driver intention to travel in the steered direction based on the information about the vehicle dynamics, e.g. steering wheel angle and speed.

Adaptive Cruise Control (ACC) systems may also take into account information about vehicle dynamics and vehicle environment. This information about vehicle dynamics may include a vehicle speed set by the driver, and a desired following distance behind a leading vehicle, also potentially set by the driver. Based on this information about vehicle dynamics and vehicle environment, ACC systems may maintain both a vehicle speed and a following distance behind a leading vehicle. In this manner, ACC systems also may make a simple assumption of driver intention to maintain a set speed or following distance based on the settings made by the driver.

Blind spot detection systems may also take into account information about vehicle dynamics and vehicle environment. The information about vehicle dynamics may include an activation of a lane change indicator by the driver, and a steering wheel angle. Further, the blind spot detection systems may sense the presence of vehicles in a blind spot of the driver. Based on this information about vehicle dynamics and vehicle environment, blind spot detection systems may provide a warning to a driver if vehicles are present in a blind spot. In this manner, blind spot detection systems also may make a simple assumption of driver intention to make a lane change based on the activation of the lane change indicator by the driver, or based on the information about the vehicle dynamics, e.g. steering wheel angle. Further, blind spot detection systems also simply assume that a driver will look only to the side rear view mirrors, but not to the blind spot; thus, blind spot detection systems simply provide a visual warning on the side rear view mirrors.

Electronic Stability Program (ESP) systems may also take into account information about vehicle dynamics. This information about vehicle dynamics may include wheel speed, engine torque, yaw rate of the vehicle, steering wheel angle, and throttle position. Based on this information about vehicle dynamics, ESP systems may modulate wheel speed to maintain stable vehicle operation under particular driving conditions. In this manner, ESP systems also may make a simple assumption of driver intention to operate the vehicle in a certain manner based on the information about the vehicle dynamics, e.g. steering wheel angle and throttle position.

U.S. Patent Application Publication No. 2007/0129815 describes a haptic control command input device that balances automatically generated control commands of an automatic system with manual control command inputs of a user. The haptic control command input device simply assumes that the manual control command inputs of the user are the intentions of the user. In addition, there may also be coupling to states of an operator, although no further description of this possible coupling is provided.

PCT International Published Patent Application No. WO 2005/118372 describes a method for holding the course of a vehicle and for warning the driver by deducing a risk potential from the vehicle driving situation and driver behavior based on vehicle dynamics. The method exerts influence on both the driver and the vehicle in distinctly different steps depending on the risk potential.

In all of the systems mentioned above that include some degree of driver input, it is simply assumed by the driver assistance systems that any change in the information regarding vehicle dynamics, e.g., steering wheel angle and activation of other buttons/functions, is a direct result of an intentional input by a driver. However, this assumption may not always be accurate, as some of the changes to the information regarding vehicle dynamics may actually be the result of driver unawareness, or even loss of control. Thus, driver assistance systems may benefit from more reliable information about driver intention. Therefore, there is believed to be a need for a more reliable system for estimating driver intention and controlling driver assistance systems through active analysis of information regarding driver intention.

### SUMMARY

Example embodiments of the present invention provide a system and a method for estimating a driver intention for driver assistance system control, by which more reliable and accurate functioning of driver assistance systems may be achieved.

For example, a system for estimating a driver intention for driver assistance system control is provided, which includes an analysis device configured to receive data from each of at least one vehicle environment sensor, at least one vehicle dynamics sensor, and at least one driver attributes sensor, wherein the analysis device is configured to predict the driver intention based on the received data; and a control device configured to control a vehicle and driver based at least partially on the predicted driver intention. This system uses data from the vehicle environment, vehicle dynamics, and driver attributes in order to estimate information about the driver's intent.

The at least one driver attributes sensor provides data regarding particular attributes of the driver. This driver attributes data may include data related to:
a) a head pose;
b) a head orientation;
c) an eye gaze;
d) an eye open or closed state;
e) a body position;
f) a body movement;
g) a hand position;
h) a hand movement;
i) a hand grasp;
j) a usage of vehicle controls;
k) a foot position;
l) a foot movement;
m) other attributes of the driver; and/or
n) combinations thereof.

The vehicle controls used by the driver may include a MMI knob, radio controls, climate controls, and other controls inside a vehicle, etc. The driver attributes data may be gathered by:
a) a vision sensor;
b) a capacitive sensor;
c) a resistive sensor;
d) a micro bolometer;
e) an infrared sensor;
f) an ultrasound sensor;
g) a vehicle controls sensor;
h) other types of sensors; and/or
i) combinations thereof.

Based on the driver attributes data gathered by the at least one driver attributes sensor, the analysis device may recognize statistical patterns in the data that represent distinctive driver task patterns. These distinctive driver task patterns, when recognized, may then indicate that a driver is undertaking a particular driver task. However, these distinctive driver task patterns may not reliably describe a particular driver task. Therefore, the distinctive driver task patterns may be placed into context by considering further information regarding the vehicle environment and vehicle dynamics.

The at least one vehicle environment sensor provides data regarding the surroundings of the vehicle. This vehicle environment data may include data regarding a roadway, pedestrians, vehicles, other objects that may be present in the surroundings of the vehicle, and combinations thereof. The vehicle environment data may be gathered by:
a) a radar sensor;
b) a vision sensor;
c) LIDAR;
d) a 3D time-of-flight sensor;
e) an ultrasound sensor;
f) a GPS sensor;
g) other sensors; and/or
h) combinations thereof.

The radar sensor may include an adaptive cruise control radar sensor and/or a short range wide angle radar sensor.

The at least one vehicle dynamics sensor provides data regarding the dynamic functions of the vehicle. This vehicle dynamics data may include data regarding:
a) vehicle speed;
b) wheel speed;
c) engine torque;
d) throttle position;
e) braking force;
f) steering wheel angle;
g) other dynamic characteristics of the vehicle; and/or
h) combinations thereof.

The vehicle dynamics data may be gathered by speed sensors, position sensors, force sensors, other sensors, and combinations thereof.

Upon receiving data regarding the vehicle environment, vehicle dynamics, and driver attributes from each of the at least one vehicle environment sensor, the at least one vehicle dynamics sensor, and the at least one driver attributes sensor, the analysis device may recognize driver intention patterns in the received data. In order to recognize these driver intention patterns, the analysis device may process the received data using computer learning models, such as a Hidden Markov Model and a Sparse Bayesian Learning Model, computer vision algorithms, and other analysis methods, etc. These recognized driver intention patterns may then indicate that a driver is undertaking a particular action.

Each time the analysis device recognizes a driver intention pattern, the analysis device may calculate a probability of the driver intention to undertake a particular action. If the calculated probability of the driver intention meets or exceeds a threshold value, the analysis device may then predict the driver intention to undertake the particular action.

The driver intention may be, for example, one of the following:
a) “change lane on highway driving for passing another vehicle;”
b) “change lane on highway driving to allow another vehicle to pass;”
c) “change lane on highway for evasive maneuver;”
d) “change lane on urban driving;”
e) “speed up;”
f) “slow down;”
g) “stop;”
h) “maintain lane position;”
i) “make a right turn;”
j) “make a left turn;”
k) “take next exit;”
l) “reversing;”
m) “inattention;” and/or
n) others.

For the case in which the calculated probability of the driver intention meets or exceeds a threshold value, the control device may output an assistance or countermeasure to at least one of the vehicle and the driver based at least partially on the predicted driver intention. This assistance or countermeasure may include an audible warning, a haptic warning, a visible warning, a recommended given maneuver, an automatically executed maneuver, other warnings or actions, and combinations thereof. Further, the recommended given maneuver may include braking, slowing down, speeding up, changing lanes, maintaining lane position, other maneuvers, and combinations thereof. In addition, the automatically executed maneuver may also include braking, slowing down, speeding up, changing lanes, keeping lane position, steering to maintain lane position, other maneuvers, and combinations thereof.

The features of the method for estimating driver intention have similar advantages as the features of the system for estimating driver intention.

For example, a method for estimating a driver intention for driver assistance system control includes: receiving, by an analysis device, data from each of at least one vehicle environment sensor, at least one vehicle dynamics sensor, and at least one driver attributes sensor; predicting, by the analysis device, the driver intention based on the received data; and controlling, by a control device, a vehicle and driver based at least partially on the predicted driver intention.

The method may further include recognizing, by the analysis device, distinctive driver task patterns in the data received from the at least one driver attributes sensor.

The method may further include recognizing, by the analysis device, driver intention patterns in the data received from each of the at least one vehicle environment sensor, the at least one vehicle dynamics sensor, and the at least one driver attributes sensor, in which the analysis device recognizes the driver intention patterns using a computer learning model, a computer vision algorithm, or other analysis methods.

The method may further include: determining, by the analysis device, a probability of the driver intention based on the recognized driver intention patterns; and predicting, by the analysis device, the driver intention, if the probability meets or exceeds a threshold value.

The method may further include outputting, by the control device, an assistance or countermeasure to at least one of the vehicle and the driver based at least partially on the predicted driver intention.

Example embodiments of the present invention are explained in greater detail in the following text with reference to the appended Figures.

### BRIEF DESCRIPTION OF THE DRAWINGS

FIG. 1 schematically illustrates a system for estimating a driver intention for driver assistance system control.

FIG. 2 is a schematic flow diagram of a method for estimating a driver intention for driver assistance system control.

### DETAILED DESCRIPTION

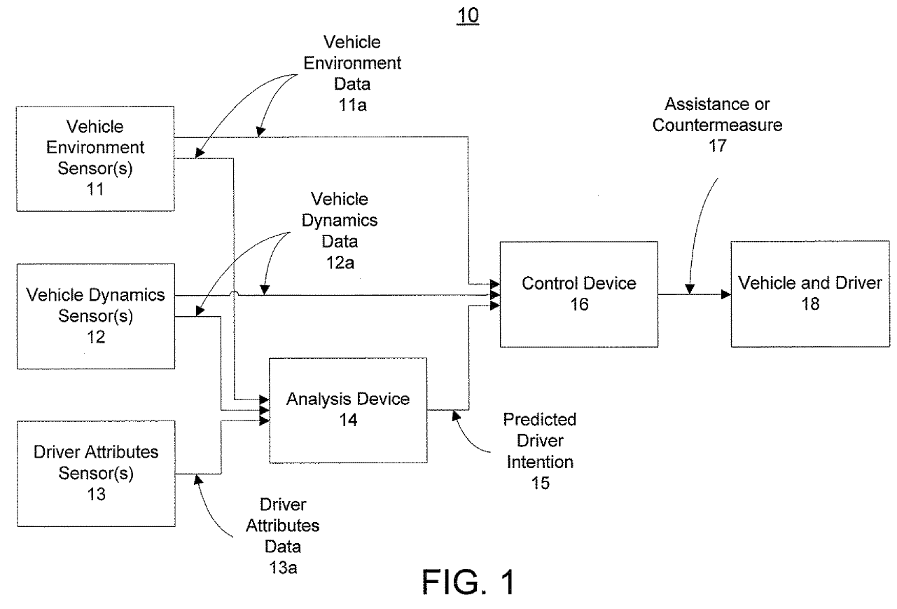

FIG. 1 schematically illustrates a system 10 for estimating a driver intention for driver assistance system control.

As illustrated in FIG. 1, the system 10 includes vehicle environment sensor(s) 11, vehicle dynamics sensor(s) 12, driver attribute sensor(s) 13, analysis device 14, control device 16, and vehicle and driver 18.

The vehicle environment sensor(s) 11 gather vehicle environment data 11a regarding the surroundings of the vehicle and driver 18. As discussed above, this vehicle environment data 11a may include data regarding a roadway, pedestrians, vehicles, other objects that may be present in the surroundings of the vehicle, and combinations thereof, etc. The vehicle environment data 11a may be gathered by many different types of sensors, as set forth above.

The vehicle dynamics sensor(s) 12 gather vehicle dynamics data 12a regarding the dynamic functions of the vehicle. As discussed above, this vehicle dynamics data 12a may include many different dynamic characteristics of the vehicle, and combinations thereof. The vehicle dynamics data 12a may also be gathered by many different types of sensors, as set forth above.

The driver attributes sensor(s) 13 gather driver attributes data 13a regarding attributes of the driver. As discussed above, this driver attributes data 13a may include many different attributes of the driver that may be meaningful in determining a driver's intent, and combinations thereof. The driver attributes data 13a may also be gathered by many different types of sensors, as set forth above.

The driver attributes data 13a by itself may be analyzed by the analysis device 14, in order to recognize statistical patterns in the driver attributes data 13a that represent distinctive driver task patterns. These distinctive driver task patterns, when recognized, may then indicate that a driver is undertaking a particular driver task. However, these distinctive driver task patterns may not reliably describe a particular driver task. For example, a single distinctive driver task pattern may precede multiple possible driver tasks. That is, a driver may behave in a similar manner before undertaking multiple, different driver tasks. In order to clarify this ambiguity, therefore, the driver attributes data 13a may be placed into context by additionally considering the vehicle environment data 11a and the vehicle dynamics data 12a.

Thus, each of the vehicle environment sensor(s) 11, vehicle dynamics sensor(s) 12, and driver attributes sensor(s) 13 provide their measured data 11a, 12a, 13a, respectively, to the analysis device 14. Upon receiving the vehicle environment data 11a, vehicle dynamics data 12a, and driver attributes data 13a, the analysis device 14 analyzes the data in order to recognize driver intention patterns in the received data 11a, 12a, 13a. In this manner, the possible ambiguity regarding distinctive driver task patterns determined from driver attributes data 13a alone may be resolved by placing the distinctive driver task patterns in context with both vehicle environment data 11a and vehicle dynamics data 12a.

In order to recognize the driver intention patterns, the analysis device 14 may process the received data 11a, 12a, 13a using computer learning models, such as a Hidden Markov Model and a Sparse Bayesian Learning Model, computer vision algorithms, and other analysis methods, etc. These recognized driver intention patterns then unambiguously indicate that a driver is intending to undertake a particular action. Some examples of particular actions that may be intended by a driver are set forth above, including, e.g. changing lanes in particular situations, speeding up, stopping, slowing down, turning, reversing, inattention, and others.

When the analysis device 14 recognizes a driver intention pattern corresponding to a particular action, the analysis device 14 calculates a probability of the driver intention to undertake a particular action. If the calculated probability of the driver intention to undertake a particular action meets or exceeds a threshold value, the analysis device 14 may then predict the driver intention to undertake the particular action. The analysis device 14 outputs this predicted driver intention 15 to the control device 16.

For the case in which the calculated probability of the driver intention meets or exceeds the threshold value, the control device 16 receives, in addition to the predicted driver intention 15 from the analysis device 14, the vehicle environment data 11a and vehicle dynamics data 12a. Based on the data 11a, 12a, and the predicted driver intention 15, the control device 16 outputs an assistance or countermeasure 17 to at least one of the vehicle and the driver 18. The assistance or countermeasure 17 may include many different types of warnings and actions, including, e.g., an audible warning, a haptic warning, a visible warning, a recommended given maneuver, an automatically executed maneuver, other warnings or actions, and combinations thereof. Further, the recommended given maneuver may include many different maneuvers, as set forth above, and combinations thereof. In addition, the automatically executed maneuver may also include many different maneuvers, as set forth above, and combinations thereof.

The control device 16 may be similar to an existing driver assistance system, including, but not limited to, the examples discussed above. However, the control device 16 of FIG. 1 is particularly configured to receive vehicle environment data 11a, vehicle dynamics data 12a, and a predicted driver intention 15 from an analysis device 14, and to output an assistance or countermeasure 17 to a vehicle and driver 18, at least partially based on the predicted driver intention 15.

Further, although the control device 16 is illustrated as being physically separate from the analysis device 14 in FIG. 1, the control device 16 may instead be joined to or integral with the analysis device 14.

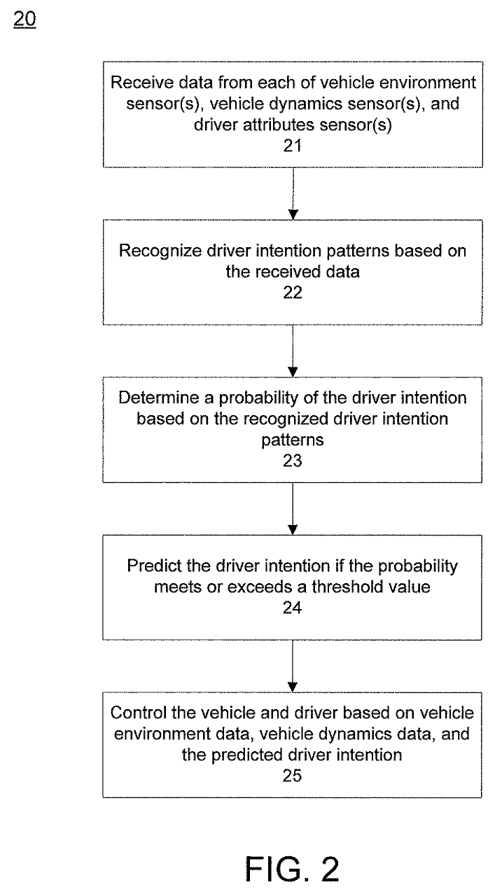

FIG. 2 schematically illustrates a flow diagram of a method 20 for estimating a driver intention for driver assistance system control.

As illustrated in FIG. 2, the method 20 begins at action 21, in which the analysis device 14 receives vehicle environment data 11a from the vehicle environment sensor(s) 11, vehicle dynamics data 12a from the vehicle dynamics sensor(s) 12, and driver attributes data 13a from the driver attributes sensor(s) 13.

Then, in action 22, the analysis device 14 analyzes the data in order to recognize driver intention patterns in the received data 11a, 12a, 13a. In order to recognize the driver intention patterns, the analysis device 14 may process the received data using computer learning models, such as a Hidden Markov Model and a Sparse Bayesian Learning Model, computer vision algorithms, and other analysis methods. These recognized driver intention patterns indicate that a driver is intending to undertake a particular action.

In the next action 23, each time the analysis device 14 recognizes a driver intention pattern corresponding to a particular action, the analysis device 14 determines a probability of the driver intention to undertake the particular action based on the recognized driver intention pattern.

In action 24, the analysis device 14 compares the calculated probability of the driver intention to a threshold value. If the calculated probability of the driver intention to undertake a particular action meets or exceeds the threshold value, the analysis device 14 then predicts the driver intention to undertake the particular action.

In action 25, the control device 16 receives the predicted driver intention 15 from the analysis device, the vehicle environment data 11a from the vehicle environment sensor(s) 11, and the vehicle dynamics data 12a from the vehicle dynamics sensor(s) 12. Based on this received information, the control device 16 determines appropriate assistance and countermeasures 17 for controlling the vehicle and driver 18.

### Exemplary Embodiments

A stop-and-go pilot is an exemplary embodiment of a driver assistance system for which an estimation of driver intention may be provided. This system is designed to drive autonomously in a traffic jam. In heavy traffic situations, safety is a primary issue because unpredicted obstacles or problems may occur at any time. However, it is possible that a driver may not be paying attention to the vehicle surroundings in such a traffic jam at all times. Because this system seeks to drive the vehicle autonomously in such heavy traffic situations, the system requires knowledge about the driver intention, particularly the level of driver attention. Other aspects of driver intention may also be important to this system, in addition to the level of driver attention.

By recognizing the level of driver attention, the system may be able to ensure safety of the vehicle and driver at all times by adjusting the sensing needs of the vehicle. For example, if a driver is not paying attention such that one full minute may elapse before the driver is able to regain full control of the vehicle, this system may adjust in order to detect all possible dangers within an approximately one-minute time horizon. On the other hand, if the driver is not paying attention such that only five seconds may elapse before the driver is able to regain full control of the vehicle, this system may adjust in order to detect all possible dangers only within an approximately five-second time horizon. Further, based on the level of driver attention, the system may adjust threshold values for outputting warnings to the driver.

Thus, recognition of the driver intention, e.g., the level of driver attention, is critical to ensuring safety of the vehicle and passengers by this system.

In this exemplary embodiment, in order to determine driver intention, head movement, head pose, body movement, and body pose may be sensed using a marker-based system, such as that made by Vicon. Five sensors are placed in various locations around the driver's head, allowing the capture of head movement and head pose data in six degrees of freedom, e.g., three for head position and three for head orientation (roll, pitch, yaw). In addition, multiple sensors are placed on other locations of the driver's body, including the hands, arms, legs, feet, and torso, allowing the capture of three-dimensional data for all parts of the driver's body. In order to sense the multiple sensors on the driver's head and body, various cameras and illuminators are used, including optical motion capture cameras, visible light-sensitive cameras, infrared light-sensitive cameras, and infrared illuminators. Further, in order to detect a driver's eye gaze, a monocular camera is used to capture infrared reflection from the retina of the eye. Other types of sensors, cameras, illuminators, and other equipment may also be used to determine the driver intention.

Using the above-described marker-based system, driver attributes data are gathered regarding head movement, eye gaze, and body pose. Then, the data is analyzed for driver intention patterns, and a Sparse Bayesian Learning Model may be used to attune the recognized driver intention patterns based on the behavior of particular measured drivers. In this manner, the system may be able to adapt to each individual driver, by monitoring the driver attributes data. Other machine learning, computer vision algorithms, and analysis methods may be used for this analysis.

A heading control is another exemplary embodiment of a driver assistance system for which an estimation of driver intention may be provided. This system is designed to actively apply torque to a steering wheel of a vehicle in order to keep the vehicle in the current lane. For the proper operation of this system, the driver intention may be important for several purposes.

For example, the driver intention may be to make a lane change. When such a maneuver is intended, the heading control system should not impede the lane change operation. Thus, the actively applied torque of this system may be decreased or completely removed. However, this system should recognize the driver intention to make a lane change in order to permit an unimpeded lane change. Without such a recognized driver intention, this system may instead create a more hazardous driving condition by preventing the driver's intended lane change.

In addition, the driver intention may be inattention to the vehicle surroundings. In such a situation, the heading control system may be adjusted to apply greater lanekeeping forces to the vehicle. Without a recognition of the driver inattention, this system may simply continue to operate under the assumption that the driver is currently attentive to the vehicle surroundings, thereby not providing an optimal degree of safety to the vehicle and passengers. Alternatively, for the case of driver inattention, the heading control system may be completely shut off, and a warning may be issued to the driver, so that the driver is forced to pay attention to the vehicle surroundings. This alternative may also prevent a driver from purposefully not paying attention while driving. Thus, without a recognition of the driver inattention, this system would not be able to maintain and/or increase the safety of the vehicle and passengers by these and other alternative strategies.

Further, the driver intention may be to make an evasive maneuver while driving on a highway. When such an evasive maneuver is intended, the heading control system should not impede the evasive lane change operation. Generally, when such evasive maneuvers are intended while driving on a highway, the window of time available to make the maneuver is very small, and so a quick reaction is important to maintain safety. Thus, as described above with regard to the intended lane change operation, the actively applied torque of this system may be decreased or completely removed. However, this system should recognize the driver intention to make an evasive maneuver in order to permit the evasive lane change. Without such a recognized driver intention, this system may instead create a more hazardous driving condition by preventing or impeding the driver's evasive maneuver.

Moreover, the driver intention may be to maintain the current lane position. This is the default condition for the driver intention, and under this driver intention, the heading control system will be active and functioning normally. Even in this default condition, recognition of the driver intention may serve to reinforce the present functioning state of this system, leading to more accurate functioning of the system and greater overall safety to the vehicle and passengers. Without such a recognized driver intention, this system may function under an assumed intention to maintain the current lane position, as opposed to an actual driver intention to maintain the current lane position.

Thus, the exemplary embodiment of the heading control system requires knowledge about the driver intention, e.g., the lane keeping intent and the lane change intent. Other aspects of driver intention may also be important to this system, in addition to the lane keeping intent and lane change intent.

In order to detect this driver intention, e.g. lane keeping intent and lane change intent, the system may measure head pose and eye gaze, as well as their history, to determine the frequency with which the driver has been scanning the vehicle surroundings. In addition, the system may also measure hand position, hand movement, and hand grasp to determine the next possible steering wheel movement. Other driver attributes may also be measured to assist in determining the driver intention. Further, this system may also consider the correlation of the sensed vehicle environment to navigation data and lane position information. Other data regarding the vehicle environment and vehicle dynamics may also be used to assist in determining the driver intention.

As set forth above, the data may be analyzed for driver intention patterns, e.g., lane keeping intent and lane change intent, and various machine learning, computer vision algorithms, and other analysis methods may be used to recognize driver intention patterns.

A city adaptive cruise control (City ACC) is yet another exemplary embodiment of a driver assistance system for which an estimation of driver intention may be provided. This system is designed to control the vehicle trajectory and speed during city driving. For the proper operation of this system, it requires knowledge about the driver intention, e.g., making a right or left turn at an intersection. Other aspects of driver intention may also be important to this system, in addition to making a right or left turn at an intersection.

In order to detect this driver intention, e.g., making a right or left turn at an intersection, the system may measure driver attributes including hand position, hand movement, hand grasp, head pose, eye gaze, foot movement, and foot position to determine a possible turn at an intersection. Other driver attributes may also be measured to assist in determining the driver intention. Further, this system may also consider vehicle dynamics data such as vehicle speed, and the correlation of the sensed vehicle environment to navigation data. Other data regarding the vehicle environment and vehicle dynamics may also be used to assist in determining the driver intention.

As set forth above, the data may be analyzed for driver intention patterns, e.g., making a right or left turn at an intersection, and various machine learning, computer vision algorithms, and other analysis methods may be used to recognize driver intention patterns.

Beyond the above-mentioned exemplary embodiments of driver assistance systems, an estimation of driver intention may also be provided in systems such as Driver Assistance, Adaptive Cruise Control, Pedestrian Protection, Lane Departure Warning, Intersection Assistance, and many others.

The individual components of the system and method for estimating a driver intention may be implemented entirely or partially in hardware and/or software, or be at least partially integrated in a system having a programmable computer.

What is claimed is:

1. A system for estimating a driver intention for driver assistance system control of a vehicle, comprising:
an analysis device configured to receive data from each of at least one vehicle environment sensor, at least one vehicle dynamics sensor, and at least one driver attributes sensor, the analysis device configured to predict the driver intention based on the received data; and
a control device configured to control the vehicle based at least partially on the predicted driver intention.

2. The system according to claim 1, wherein the at least one driver attributes sensor includes at least one of: (a) a vision sensor; (b) a capacitive sensor; (c) a resistive sensor; (d) a micro bolometer; (e) an infrared sensor; (f) an ultrasound sensor; and (g) a vehicle controls sensor.

3. The system according to claim 1, wherein the at least one driver attributes sensor is configured to measure at least one of: (a) a head pose; (b) a head orientation; (c) an eye gaze; (d) an eye open or closed state; (e) a body position; (f) a body movement; (g) a hand position; (h) a hand movement; (i) a hand grasp; (j) a usage of vehicle controls; (k) a foot position; and (l) a foot movement.

4. The system according to claim 3, wherein the vehicle controls include at least one of: (a) a MMI knob; (b) radio controls; and (c) climate controls.

5. The system according to claim 1, wherein the vehicle environment sensor includes at least one of: (a) a radar sensor; (b) a vision sensor; (c) LIDAR; (d) a 3D time-of-flight sensor; (e) an ultrasound sensor; and (f) a GPS sensor.

6. The system according to claim 5, wherein the radar sensor includes at least one of (a) an adaptive cruise control radar sensor and (b) a short range wide angle radar sensor.

7. The system according to claim 1, wherein the analysis device is configured to recognize distinctive driver task patterns in the data received from the at least one driver attributes sensor.

8. The system according to claim 1, wherein the analysis device is configured to recognize driver intention patterns in the data received from each of the at least one vehicle environment sensor, the at least one vehicle dynamics sensor, and the at least one driver attributes sensor.

9. The system according to claim 8, wherein the analysis device is configured to determine a probability of the driver intention based on the recognized driver intention patterns.

10. The system according to claim 9, wherein the analysis device is configured to predict the driver intention if the probability meets or exceeds a threshold value.

11. The system according to claim 8, wherein the analysis device is configured to recognize the driver intention patterns using at least one of a computer learning model and a computer vision algorithm.

12. The system according to claim 11, wherein the computer learning model includes at least one of (a) a Hidden Markov Model and (b) a Sparse Bayesian Learning Model.

13. The system according to claim 1, wherein the driver intention includes at least one of: (a) an intention to change lanes in highway driving for passing another vehicle; (b) an intention to change lanes in highway driving to allow another vehicle to pass; (c) an intention to change lanes on a highway for an evasive maneuver; (d) an intention to change lanes in urban driving; (e) an intention to speed up; (f) an intention to slow down; (g) an intention to stop; (h) an intention to maintain a lane position; (i) an intention to make a right-hand turn; (j) an intention to make a left-hand turn; (k) an intention to take a next exit; (l) an intention to reverse; and (m) an intention to be inattentive.

14. The system according to claim 1, wherein the control device is configured to output at least one of (a) an assistance and (b) countermeasure to at least one of (a) the vehicle and (b) the driver based at least partially on the predicted driver intention.

15. The system according to claim 14, wherein the at least one of (a) the assistance and (b) the countermeasure includes at least one of: (a) an audible warning; (b) a haptic warning; (c) a visible warning; (d) a recommended given maneuver; and (e) an automatically executed maneuver.

16. The system according to claim 15, wherein the recommended given maneuver includes at least one of: (a) brake; (b) slow down; (c) speed up; (d) change lane; and (e) maintain lane position.

17. The system according to claim 15, wherein the automatically executed maneuver includes at least one of: (a) brake; (b) slow down; (c) speed up; (d) change lane; (e) keep lane; and (f) steer to maintain lane position.

18. A method for estimating a driver intention for driver assistance system control of a vehicle, comprising:
receiving, by an analysis device, data from each of at least one vehicle environment sensor, at least one vehicle dynamics sensor, and at least one driver attributes sensor;
predicting, by the analysis device, the driver intention based on the received data; and
controlling, by a control device, the vehicle based at least partially on the predicted driver intention.

19. The method according to claim 18, further comprising recognizing, by the analysis device, distinctive driver task patterns in the data received from the at least one driver attributes sensor.

20. The method according to claim 18, further comprising recognizing, by the analysis device, driver intention patterns in the data received from each of the at least one vehicle environment sensor, the at least one vehicle dynamics sensor, and the at least one driver attributes sensor.

21. The method according to claim 20, further comprising determining, by the analysis device, a probability of the driver intention based on the recognized driver intention patterns.

22. The method according to claim 21, further comprising predicting, by the analysis device, the driver intention, if the probability meets or exceeds a threshold value.

23. The method according to claim 20, wherein the analysis device recognizes the driver intention patterns using at least one of (a) a computer learning model and (b) a computer vision algorithm.

24. The method according to claim 18, further comprising outputting, by the control device, at least one of (a) an assistance and (b) countermeasure to at least one of (a) the vehicle and (b) the driver based at least partially on the predicted driver intention.
